(19) United States
(12) Patent Application Publication
(10) Pub. No.: US 2015/0301553 A1
(43) Pub. Date: Oct. 22, 2015

(54) ACTUATOR WITH HYBRID ACTUATION FOR A FORCE FEEDBACK INTERFACE

(71) Applicant: Commissariat à l'énergie atomique et aux énergies alternatives, Paris (FR)

(72) Inventors: Carlos Rossa, Montrouge (FR); José Lozada, Massy (FR); Alain Micaelli, Fontenay aux Roses (FR)

(21) Appl. No.: 14/408,771

(22) PCT Filed: Jun. 18, 2013
(86) PCT No.: PCT/EP2013/062655

§ 371 Date: Dec. 17, 2014

(30) Foreign Application Priority Data
Jun. 20, 2012 (FR) 12 55783

(51) Int. Cl. G05G 5/03; F16D 67/06

(52) U.S. Cl. CPC G05G 5/03; F16D 67/06

(57) ABSTRACT

Actuator for a force feedback interface comprising a shaft integral in rotation with an interacting member of said interface, an electric motor driving in rotation the shaft (3) in a clockwise direction and in an anti-clockwise direction, a first free-wheel device (4) mounted on the shaft (3) and a first braking system (8) capable of braking the rotation of the shaft (3) by the intermediary of the free-wheel device (8), a second free-wheel device (6) mounted on the shaft (3) in opposition with respect to the first free-wheel device (4), a second braking system (10) capable of braking the rotation of the shaft (3) by the intermediary of the second free-wheel device (6) in a direction opposite that of the first braking system (8). The motor is able to apply an active load to the shaft (3) in the direction opposite that of the braking force.

### TECHNICAL FIELD AND PRIOR ART

This invention relates to an actuator with hybrid actuation for a force feedback interface and to an interface comprising such an actuator.

The force feedback interfaces of prior art can implement motors or brakes that can be controlled in order to generate the interaction forces.

In the case where a motor is used, there is a compromise between the stiffness and the stability of the interface via the control gains.

In the case where a brake is used, the system is intrinsically stable but it is impossible to restore the energy to the user.

Interfaces have therefore been carried out that implement hybrid actuators which associate a direct current motor with a brake that can be controlled. The motor then provides an active behaviour to the interface while the brake is used to provide the stability for the system or to dissipate substantial quantities of energy. However, if the brake and the motor are used simultaneously, the active behaviour of the motor is naturally cancelled by the brake. In a haptic interface with two degrees of freedom for example, it becomes impossible to recreate the forces of interaction in a wide range of directions by using the brakes and the motor at the same time. Furthermore, if the force imposed by the user is less than the setpoint force imposed by the actuator, the interface must have a predominant effect on the user. This is carried out naturally when the haptic rendering is provided by the motor but remains imperceptible in the case where the brake is activated. In order to provide a realistic haptic rendering, it is then necessary to combine the hybrid actuator with an interaction force sensor, which renders the system voluminous and substantially more expensive.

The document F. Conti and O. Khatib, “A new actuation approach for haptic Interface Design”—In The international Journal of Robotics Research 2009 describes an actuator called “H2O” that combines the use of an angular spring, a brake and a motor in a parallel configuration, with two position sensors that measure the compression of the spring. The output of the actuator is characterised by the sum of the torques generated by each actuator. By introducing a spring, it is possible to store the energy coming from the exterior via the actuating of the brake. When the brake is released, the user can rotate the main axis without resistance. However, when the brake is activated, a force proportional to the displacement is imposed at the output. The motor is activated to offset the output torque and the setpoint.

The actuating of the system is controlled by a simple comparison between the sign of the setpoint and that of the force stored by the spring. If the signs coincide, the setpoint torque is controlled by the brake and the error between the setpoint and the spring torque is offset by the motor. However if the signs of the setpoint and that of the force stored by the spring are different it is necessary to release the brake in order to cancel the energy stored and for the motor to assume the setpoint. When the energy of the spring becomes zero, it is again possible to actuate the brake and the system returns to the first operating mode. The adding of an elastic element in the actuator substantially reduces the bandwidth of the manipulator that can be controlled. The response time of the brake is substantially affected.

The document O. Schneider and J. Troccaz. “PADyC: A synergistic robot for cardiac puncturing”—In Proceedings of the 2000 IEEE international conference on robotics & automation describes the “PADyC” mechanism associating two free-wheels mounted in parallel. Each wheel is connected to a motor programmed to rotate solely in the free direction of the wheel that it is associated with. The two free-wheels are activated when the two motors are inactive, in this case no movement of the axis of rotation is possible. When the two motors are in rotation, the two free-wheels are deactivated, any movement of the axis is then allowed. If only one of the free-wheels is active, i.e. the motor associated with the free-wheel is stopped while the motor of the other wheel is active, the rotation of the axis is then allowed in the direction of rotation of the activated motor. By controlling the speed of rotation of the motors it is possible to control the amplitude of the movements of the axes. The actuating of the motors as such allows for the movement of the axis of rotation in one direction. Consequently, the system is not motorised as the motors do not provide any active torque.

### DISCLOSURE OF THE INVENTION

It is consequently a purpose of this invention to offer an actuator for a force feedback interface capable of providing an active or dissipative torque with a number of elements substantially close to that of actuators of prior art and which have a reduce encumbrance.

The purpose of this invention is achieved by an actuator comprising an electric motor driving a shaft able to rotate about its axis and able to transmit the forces to an operator, and free-wheel means able to apply a braking force on the shaft in such a way that the motor can drive the shaft in a direction opposite that in which the braking force is exerted. The actuator according to the invention can then provide to the interface an active or dissipative torque without adding any element that can negatively affect the bandwidth of the system. The active torque can be added to the dissipative torque.

In other terms, the motor can exert an active load on the shaft without the latter being cancelled by the dissipative loads generated by the activated braking system, since the shaft can be free in rotation in the direction opposite that in which the braking force is exerted.

The actuator can be controlled in terms of force by analogue or digital controllers. Thanks to the invention, only the measurement of the position of the axis of rotation is required. The mathematical model of the elements to simulate is implemented in the simulator and the global system can be controlled by a microcontroller that carries out the sharing of the tasks between the brakes and the motor.

The tactile simulation interface according to the invention has the advantage of being able to operate without any prior knowledge of the elements to be simulated.

According to an example of a first embodiment, the motor torque is directly transmitted to the output of the shaft in interaction with the operator, and the actuator comprises a free-wheel and a braking system that applies a braking to the shaft by the intermediary of the free-wheel. For force feedback applications, this makes it possible to combine the substantial braking forces supplied by the brake to the active behaviour of the motor without the latter being cancelled by the brake. This actuator operates only in a single direction of rotation.

According to another example of the first embodiment, the motor torque is directly transmitted to the output of the shaft in interaction with the operator, and the actuator comprises two free-wheels mounted opposite and a braking system associated with each free-wheel. The braking in a unidirectional rotation is applied to the shaft by the intermediary of the free-wheels. Subsequently, the braking torque of the brake is transmitted to the axis only in the direction of blockage of the free-wheel that it is associated with. The motor is directly connected to the output axis and can drive the latter in both directions. For force feedback applications, this makes it possible to combine the substantial braking forces supplied by the brakes with the active behaviour of the motor without the latter being cancelled by the brakes. This actuator operates in both directions of rotation.

In a second embodiment, means connect the first and the second shaft and are such that they invert the directions of rotation of the shaft. For example, this is a gearbox.

For example, the system or systems are magneto-rheological.

The invention makes it possible to combine the dissipative loads of the braking systems and the active loads of the motor without the latter being cancelled by the dissipative component. Consequently, the braking system and the motor can be activated simultaneously. As it can be adapted to a wide range of haptic applications, this actuator makes it possible to improve the performances of the interfaces. Furthermore, it becomes possible to associate a braking system that has a torque capacity that is much more substantial than that of the motor, which minimises the energy required for synthesising a haptic rendering.

The subject-matter of the present invention then is an actuator for a force feedback interface comprising a first shaft intended to be integral in rotation with an interacting member of said interface, an electric motor able to put into rotation the first shaft in a clockwise direction and in an anti-clockwise direction, a first free-wheel device mounted on said first shaft and a first braking system capable of braking the rotation of said first shaft by the intermediary of the free-wheel device.

The actuator can comprise a second free-wheel device mounted on said first shaft opposite with respect to the first free-wheel device, a second braking system capable of braking the rotation of said shaft by the intermediary of the second free-wheel device in a direction opposite that of the first braking system.

Another subject-matter of the present invention is an actuator for a force feedback interface comprising a first shaft intended to be integral in rotation with an interacting member of said interface, an electric motor able to put into rotation the first shaft in a clockwise direction and in an anti-clockwise direction, a second shaft integral in movement with the first shaft, a first free-wheel device mounted on the second shaft and a first braking system capable of braking the rotation of the second shaft by the intermediary of the free-wheel device, and means connecting the second shaft to the first shaft, said means being such that the direction of rotation of the first and of the second shaft are identical or opposite.

The means for selecting the direction wherein the first shaft is braked are formed advantageously by a gearbox. The gearbox can have different transmission ratios.

In an embodiment, the first and/or the second braking systems are magneto-rheological braking systems.

Preferably, the motor is a direct current motor.

According to a characteristic of the invention, the actuator can comprise a position sensor of the first shaft.

According to another characteristic of the invention, the braking system or systems have a torque capacity that is greater than that of the motor.

Another subject-matter of the present invention is an interface comprising at least one actuator according to the invention, an interacting member with the operator integral in rotation with the first shaft and a controller controlling the motor and the braking system or systems.

The actuator can be advantageously controlled in terms of force.

The controller can comprise means for comparing the sign of the speed of the first shaft and that of the setpoint.

In an embodiment, the controller controls one of the braking systems and the motor so that they both brake the rotation of the first shaft.

According to a characteristic of the invention, the motor can participate in the braking only when the speed measured is zero or when an active load is required.

Another subject-matter of the present invention is a method for controlling an actuator of a force feedback interface according to the invention, comprising the steps of:
comparing the sign of the speed of rotation of the first shaft bearing the interacting member with the operator with the sign of the setpoint force,
sending a control order to the motor and/or to one of the braking systems,
applying a dissipative load and/or of an active load to said first arm.

In an embodiment, for a speed measured of the first shaft that is not zero, one or the other of the braking systems is activated in order to exert a dissipative load and the motor is activated in order to supply an active load. When the speed of the first shaft measured is zero, the motor and one or the other of the braking systems can be activated simultaneously.

In another embodiment, the motor provides a dissipative load and one or the other of the braking systems are activated when the motor reaches its saturation speed.

### BRIEF DESCRIPTION OF THE DRAWINGS

This invention shall be better understood using the following description and the annexed drawings wherein:

FIG. 1 is a diagrammatical view of an actuator according to a first embodiment,

FIG. 2 is a diagrammatical view of an actuator according to a second embodiment,

FIG. 3 is a block diagram of an example of a control of the actuator.

### DETAILED DISCLOSURE OF PARTICULAR EMBODIMENTS

The actuator which shall be described in detail has one degree of freedom.

In this application, “dissipative load” means a load intended to oppose the speed (displacement) of the operator, and “active load” means a load that is carried out in the same direction as the speed of displacement of the operator.

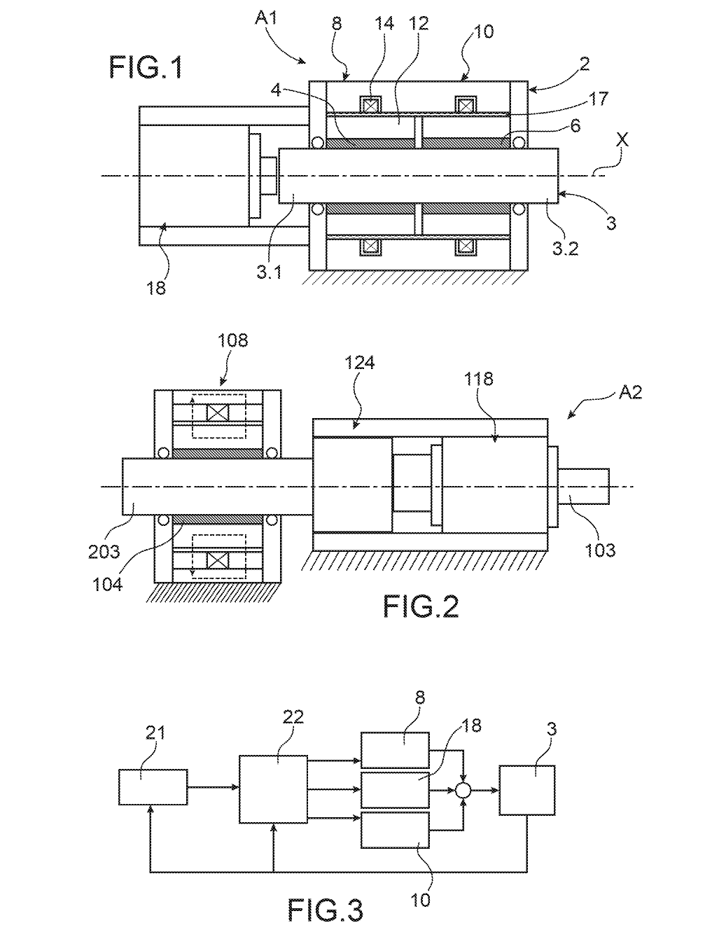

FIG. 1 shows a block diagram of an actuator A1 according to a first embodiment.

The actuator A1 comprises a frame 2 wherein a shaft 3 of axis X is mounted capable of rotating about its axis, a first free-wheel 4 mounted on the shaft 3 and a second free-wheel 6 mounted on the shaft 3. The two free-wheels 4, 6 are mounted opposite. These are for example roller free-wheels.

Recall that a free-wheel is a mechanical device for transmitting a unidirectional force. This device is well known to those skilled in the art and shall not be described in detail.

For example, the first free-wheel 4 transmits the movement of rotation in the clockwise direction and the second free-wheel 6 transmits the movement of rotation in the anti-clockwise direction.

The actuator A1 also comprises first 8 and second 10 braking systems associated to each one of the first 4 and second 6 free-wheels respectively. In such a way that, when a braking force is applied by the first braking system 8, the shaft 3 is braked in the clockwise direction and, when a braking force is applied by the second braking system 10, the shaft 3 is braked in the anti-clockwise direction.

In this application, “braking system” means a system capable of applying a dissipative load aimed at reducing the speed of rotation of a shaft, with the reduced speed able to be non-zero or zero.

In the example shown, the first 8 and second 10 braking systems are magneto-rheological braking systems.

As the two braking systems are similar, only the first one shall be described in detail.

The first system comprises a sleeve made of ferromagnetic material 12 integral with the outer periphery of the first free-wheel 4 and a magnetic field generator 14, a coil in the example shown. A radial clearance is provided between the outer periphery of the sleeve 12 and the coil 14 delimiting an annular space 16. A magneto-rheological liquid 17 fills the annular space 16.

The first braking system 8 operates in the following way: when a magnetic flow is generated by the coil 14 in the space 16, the ferromagnetic particles that compose the fluid are aligned according to the orientation of the magnetic flow and constitute chains between the walls of the fixed and mobile portions. Consequently, in order to force the movement between the walls of the layer of fluid, a force must be imposed that is greater than the interaction force of the particles in order to break the chains that have formed. This results in a resistance to the rotation of the free-wheels with respect to the frame, this resistance is proportional to the intensity of the magnetic flow generated by the coil.

Alternatively, it could be considered that the coil be integral with the free-wheel. In the example shown, the volume of magneto-rheological fluid is shared between the two braking systems, however two separate volumes could be provided.

Any other geometry of magneto-rheological brake can be considered.

Other controllable braking systems can also be used, for example of the powder brake, shoe brake, disc brake, Eddy current brake, electro-rheological brakes, etc. types.

In the example shown and advantageously, the shaft 3 is a through-shaft and comprises two longitudinal ends 3.1, 3.2 protruding on either side of the frame 2. An electric motor 18 is engaged with the shaft 3 on the end 3.1, the motor 4 can rotate in the clockwise direction and in the anti-clockwise direction. This is for example a direct current motor. The implementation of a through-shaft makes it possible to simply connect the motor directly at the output of the shaft.

The end 3.2 of the shaft 3 carries an interacting member with the operator, for example a lever (not shown).

Thanks to the invention, if a force resisting the rotation of the shaft 3 in the clockwise direction is imposed, this force is controlled in terms of intensity by the actuating of the first braking system 8 which acts on the first free wheel 4. However, thanks to the first free-wheel 4, the shaft 3 can freely rotate in the anti-clockwise direction.

The actuator A1 also comprises an angular position sensor of the shaft 3, the sensor is for example of the rotating encoding type. Other sensors can however be used, such as: inductive sensors, capacitive sensors, potentiometers, optical sensors, etc. It can also be provided to use an angular speed or angular acceleration sensor.

The actuator is controlled in terms of force by one or more analogue or digital controllers.

The force feedback interface according to the invention comprises at least one actuator according to the invention and a control member which provides for the sharing of the tasks between the members that can be controlled and which carries out the sharing of the tasks between the braking systems and the motor. The control member is for example a computer or any other control system.

FIG. 3 shows an example of a control of diagram the actuator.

The control of the actuator is based on the analysis of the interaction energy. By comparing the signs of the speed measured on the shaft 3 with the signs of the simulation setpoints emitted by a simulator 21 to the microcontroller 22, it is determined whether the force feedback interface requires a command to dissipate the energy or to have an active behaviour. The simulation setpoints are sent by the microcontroller 22 either to one of the braking systems 8, 10 and/or to the motor 18. One of the braking systems 8, 10 and/or the motor 18 impose a reaction force to the shaft 3. Then, the position of the shaft is measured, information which is set to the simulator and to the controller in order to correct or not correct the action of one of the braking systems and/or of the motor. The choice of the setpoint of the braking systems and/or of the motor depends on the direction of the speed of rotation of the shaft.

“Simulator” means the virtual environment that the mathematical model contains used for calculating setpoints of interaction forces. The virtual environment calculates the setpoints according to the position measured and/or of the speed that can be deduced from it and in particular according to the behaviour of the virtual elements to be simulated, for example the torque in a steering wheel force feedback in a racing game. The simulator is independent from the rest of the system. It varies according to the applications and is not implemented in the actuating system described. The microcontroller 22, however, receives the setpoints calculated by the virtual environment and uses the position measurement to calculate the speed or a direct measurement of the speed. It is part of the system and is responsible for the sharing of the setpoint between the various actuators. Consequently, the actuating system can be adapted to a large number of haptic applications since it is independent of any simulation.

The various operating possibilities of the actuator are as follows:

A—The two braking systems are activated: the system imposes a force that resists the rotation of the shaft 3 in both directions.

B—The first braking system 8 is activated: it impose a force that resists the rotation of the shaft in the clockwise direction of rotation. The shaft 3 can rotate freely in the anti-clockwise direction.

C—The second braking system 10 is activated: it impose a force that resists the rotation of the shaft 3 in the anti-clockwise direction of rotation. The shaft 3 can rotate freely in the clockwise direction.

D—The motor 18 is activated in the anti-clockwise direction and the first braking system 8 is activated: the first braking system 8 and the motor impose a resistance to the rotation in the clockwise direction. In the anti-clockwise direction, the motor 18 can drive the shaft 3.

E—The motor 18 is activated in the clockwise direction and the first braking system 8 is activated: the motor torque is braked by the first braking system 8. The difference between the motor torque and the braking torque is transmitted to the output.

F—The motor is activated in the clockwise direction and the second braking system 10 is activated: the second braking system 10 and the motor 18 impose a resistance to rotation in the anti-clockwise direction. In the clockwise direction, the motor 18 can drive the shaft 3.

G—The motor is activated in the anti-clockwise direction and the second braking system 10 is activated: the motor torque is braked by the second braking system 10. The difference between the motor torque and the braking torque is transmitted to the output.

Note that the operating modes E and G have a lesser interest.

The operation of the actuator of FIG. 1 according to the invention shall now be described.

First of all using the measurement of the position of the shaft 3, the speed of the shaft is determined. The sign of the speed determined as such is then compared with that of the setpoint force.

If the setpoint force has the same sign as the speed measured, it is concluded that the haptic interface must provide a dissipative load. According to the sign of the force of the setpoint, the first or second braking system or the motor is activated. A magnetic field is produced in the space C, the particles of the magneto-rheological fluid align and oppose a resistance to the rotation of the shaft.

If on the contrary, the sign of the speed and that of the setpoint force are different, the setpoint is sent to the motor 18 so that it supplies an active load and, instead of the actuator generating a force that opposes the rotation of the shaft, it imposes a force that accompanies the rotation of the shaft. Since no braking system is activated, the shaft is free to rotate in one or the other direction.

Advantageously, braking systems are chosen in such a way as to have a torque capacity that is substantially greater than that of the motor, which makes it possible to prevent the potential risks for the user that would exist if the motor were capable of imposing an excessive active load.

In the case where the motor has a reduced torque capacity with respect to that of the braking systems, the actuator can be controlled according to the following advantageous ways.

According to a first control method, the motor is used solely to provide an active torque. Except in the case where the speed measured is zero, the adapted motor and the braking system are activated. The setpoint is sent to the motor. The difference between the setpoint and the saturation of the motor is sent to the braking system. The braking system supplements the maximum torque that the motor can provide in order to provide the force required by the setpoint.

This operation makes it possible to use the braking systems more in order to dissipate energy, while the motor is activated solely in order to supply an active load or when the speed is zero. The consumption of energy is also reduced. This first control method advantageously makes it possible to render the actuator active when the operator releases the lever and is also capable of eliminating the phenomenon of collage in the simulation of a virtual wall, a phenomenon that appears when the actuator is of the solely dissipative type. Indeed, when the motor has the same torque capacity as that of the brakes, since the shaft can rotate thanks to the implementation of the free-wheel, the motor can impose an active torque which suppresses the delay that appears with passive actuators when the operator backs up when faced with the virtual wall.

According to a second control method, regardless of the speed measured, the motor provides a dissipative effort as long as the torque required by the setpoint is lower than the saturation of the motor. Once the saturation of the motor is exceeded, the braking system is activated in order to offset the difference between the setpoint and the saturation of the motor. Consequently, the motor is used to provide modest loads, which can be active or dissipative, while the braking system is used solely to provide large forces of resistance. The motor is therefore used to dissipate energy as long as the forces are weak. This technique allows the actuator to have an active behaviour with a week system of forces, i.e. forces limited to the saturation of the motor that do not have any potential risks for the user.

For example for an application to the driving systems of the steer-by-wire type, it is then possible to transmit vibrations that can be controlled to the steering wheel.

In the two control methods, the motor torque is not cancelled by the brake.

The second control method has the advantage of being sufficient for the controlling of interfaces with one or two degrees of freedom. The first control method is sufficient for the controlling of interfaces with one degree of freedom.

These two control methods are based solely on two pieces of information, the speed measured and the force calculated by the simulator. This results in that the control is independent of the simulation and does not need a measurement of the interaction force. Consequently, the actuator and its control methods can be adapted to a wide range of force feedback interfaces and can improve the performances of such devices and reduce the energy needed for the synthesis of a haptic rendering.

It has been observed that the torque/volume ratio of a magneto-rheological brake can reach 50 times that of a direct current motor. The encumbrance of an interface implementing such an actuator can therefore be reduced substantially.

In the case where it is desired that an actuator operate only in one direction of rotation, the latter comprises a motor, a braking system and a free-wheel connecting the braking system and the motor. The member that the operator manipulates is directly engaged with the shaft of the motor. If the operator turns the lever in the direction of locking of the free-wheel, the braking torque applied by the brake opposes the displacement of the member. If the operator turns the lever in the direction of unlocking of the free-wheel, the member rotates freely. On the other hand, the motor on the axis of which the member is directly engaged can exert a torque on the member in both directions of rotation. The control methods of this actuator are similar to those described hereinabove.

FIG. 2, shows a second embodiment of an actuator according to the invention wherein one of the braking systems and the associated free-wheel are replaced with a system 124 able to invert the direction of rotation, for example a gearbox.

The actuator comprises a first shaft 103 whereon is mounted a free-wheel 104 and a braking system 108, a second shaft 203 forms the through-shaft of a motor 218 of which one end is intended to be connected to an interacting member with the operator (not shown). The system of inversion 24 connects the first shaft 103 and the second shaft 203.

The braking system 108 brakes the shaft 103 in a single direction and it is the system of inversion that allows the actuator A2 to operate in a manner similar to the actuator A1 and to have the same advantages. Indeed, the system of inversion is controlled in such a way that it controls the direction of braking and thanks to the free-wheel 104, the motor 118 can rotate in the opposite direction.

The control methods are similar to those described for the first operating mode. However, instead of controlling a second braking system in order to impose a dissipative load in the direction opposite that imposed by the braking system 108 and the free-wheel 104, it is the gearbox 124 that is controlled in order to invert the direction of rotation transmitted between the first shaft 103 and the second shaft 203.

In an advantageous example, the gearbox has different transmission ratios as well as a neutral position, which makes it possible to increase the braking capacity of the braking system and to decouple the inertia of the input.

This embodiment makes it possible to suppress the inertia of a second free-wheel and of a second braking system. It also makes it possible to decouple the inertia of the braking system when, solely, the motor is used.

In order to carry out an interface with two or three degrees of freedom, two or three actuators are associated with one degree of freedom according to the invention respectively.

The actuator according to the invention can be implemented in order to carry out haptic interfaces with a force feedback, as for example steering wheels with force feedback for video games or driving systems (steer-by-wire), joysticks with force feedback, programmable buttons with force feedback, devices for medical training, manipulator arms for remote operation, etc.

What is claimed is:

1-18. (canceled)

19. Actuator for a force feedback interface comprising:
a first shaft configured to be integral in rotation with an interacting member of said interface,
an electric motor able to rotate the first shaft in a clockwise direction and in an anti-clockwise direction,
a first free-wheel device mounted on said first shaft, and
a first braking system configured to brake the rotation of said first shaft by the intermediary of the free-wheel device, in such a way that the first braking system imposes a force that resists the rotation of the first shaft in a first direction of rotation, with said force being controlled in intensity.

20. Actuator according to claim 19, comprising:
a second free-wheel device mounted on said first shaft in opposition with respect to the first free-wheel device,
a second braking system capable of braking the rotation of said first shaft by the intermediary of the second free-wheel device in a direction opposite that of the first braking system.

21. Actuator for a force feedback interface comprising:
a first shaft configured to be integral in rotation with an interacting member of said interface,
an electric motor able to rotate the first shaft in a clockwise direction and in an anti-clockwise direction,
a second shaft integral in movement with the first shaft,
a first free-wheel device mounted on the second shaft,
a first braking system able to brake the rotation of the second shaft by the intermediary of the free-wheel device,
a connector connecting the second shaft to the first shaft, said connector being such that the direction of rotation of the first shaft and of the second shaft are identical or opposite, in such a way that the first braking system imposes a force that resists the rotation of the first shaft in a first direction of rotation, with said force being controlled in intensity.

22. Actuator according to claim 21, wherein the connector is a gearbox.

23. Actuator according to claim 22, wherein the gearbox has different transmission ratios.

24. Actuator according to claim 19, wherein the first and/or the second braking system are magneto-rheological braking systems.

25. Actuator according to claim 19, wherein the motor is a direct current motor.

26. Actuator according to claim 19, comprising a position sensor of the first shaft.

27. Actuator according to claim 19, wherein the braking system or the braking systems have a torque capacity that is higher than that of the motor.

28. Interface comprising at least one actuator according to claim 19, an interacting member with the operator integral in rotation with the first shaft and a controller controlling the motor and the braking system or systems.

29. Interface according to claim 28 wherein the actuator is controlled in terms of force.

30. Interface according to claim 28, wherein the controller comprises a comparator comparing the sign of the speed of the first shaft and that of the setpoint.

31. Interface according to claim 28, wherein the controller controls one of the braking systems and the motor so that they both brake the rotation of the first shaft.

32. Interface according to claim 28, wherein the motor participates in the braking solely when the speed measured is zero or when an active load is required.

33. Method for controlling an actuator of a force feedback interface according to claim 28, comprising the steps of:
comparing the sign of the speed of rotation of the first shaft bearing the interacting member with the operator with the sign of the setpoint force,
sending a control order to the motor and/or to one of the braking systems,
applying a dissipative load and/or of an active load to said first arm.

34. Method for controlling according to claim 33, wherein, for a speed measured of the first shaft that is not zero, one or the other of the braking systems is activated in order to exert a dissipative load and the motor is activated in order to supply an active load.

35. Method for controlling according to claim 34, wherein, when the speed of the first shaft measured is zero, the motor and one or the other of the braking systems are activated simultaneously.

36. Method for controlling according to claim 33, wherein the motor provides a dissipative load and one or the other of the braking systems are activated when the motor reaches its saturation state

37. Actuator according to claim 21, wherein the first and/or the second braking system are magneto-rheological braking systems.

38. Actuator according to claim 21, wherein the motor is a direct current motor.

39. Actuator according to claim 21, comprising a position sensor of the first shaft.

40. Actuator according to claim 21, wherein the braking system or the braking systems have a torque capacity that is higher than that of the motor.

41. Interface comprising at least one actuator according to claim 21, an interacting member with the operator integral in rotation with the first shaft and a controller controlling the motor and the braking system or systems.

42. Interface according to claim 41, wherein the actuator is controlled in terms of force.

43. Interface according to claim 41, wherein the controller comprises a comparator comparing the sign of the speed of the first shaft and that of the setpoint.

44. Interface according to claim 41, wherein the controller controls one of the braking systems and the motor so that they both brake the rotation of the first shaft.

45. Interface according to claim 41, wherein the motor participates in the braking solely when the speed measured is zero or when an active load is required.

46. Method for controlling an actuator of a force feedback interface according to claim 41, comprising the steps of:
comparing the sign of the speed of rotation of the first shaft bearing the interacting member with the operator with the sign of the setpoint force,
sending a control order to the motor and/or to one of the braking systems,
applying a dissipative load and/or of an active load to said first arm.

47. Method for controlling according to claim 46, wherein, for a speed measured of the first shaft that is not zero, one or the other of the braking systems is activated in order to exert a dissipative load and the motor is activated in order to supply an active load.

48. Method for controlling according to claim 47, wherein, when the speed of the first shaft measured is zero, the motor and one or the other of the braking systems are activated simultaneously.

49. Method for controlling according to claim 46, wherein the motor provides a dissipative load and one or the other of the braking systems are activated when the motor reaches its saturation state
